(19) United States
(12) Patent Application Publication
(10) Pub. No.: US 2014/0323101 A1
(43) Pub. Date: Oct. 30, 2014

(54) Phone Number Format Suggestion

(71) Applicant: Google Inc., (US)

(72) Inventors: Shaopeng Jia, Widen (CH); Lara Jane Rennie, Zurich (CH)

(73) Assignee: Google Inc., Mountain View, CA (US)

(21) Appl. No.: 13/872,195

(22) Filed: Apr. 29, 2013

(51) Int. Cl. H04W 4/16

(52) U.S. Cl. CPC H04W 4/16
USPC 455/414.1

(57) ABSTRACT

Methods and systems include receiving a request to dial a phone number to a destination location, wherein the request to dial the phone number is received at a current location. It may be determined that the phone number is formatted to be dialed from a format location. A plurality of candidate phone numbers may be generated wherein each of the candidate phone numbers is a reformatted version of the phone number based on the destination location, the current location, and the format location. A best match candidate phone number may be identified based on a format for dialing the phone number from the current location to the destination location. The best match candidate phone number may be presented along with the plurality of candidate phone numbers, and a selection of a candidate phone number may be received.

### BACKGROUND

In general, phone number formats typically vary from one country to another. For example, in the U.S. a phone number may have the format of a 3 digit area code followed by a 7 digit number, such as 650-012-3456. In Brazil, a phone number may have the format of a 3 digit carrier code, followed by a 2 digit area code, followed by an 8 digit number, such as 041-21-0123-4567. Further, even corresponding parts of phone numbers may have different formats in different countries. For example, U.S. numbers use three digit area codes and seven digit phone numbers, while Brazilian numbers use two digit area codes and eight digit phone numbers. Also, certain countries use types of phone number information that are not used universally. For example, Brazilian dialing requires a carrier code, which is not generally required when dialing in the U.S. Additionally, in Mexico, calling from a landline phone to a mobile phone may require a non-geographical prefix 09, while calls between mobile phones must be dialed without the non-geographical prefix 09. In Colombia, for example, calling a land line number from a mobile phone within Colombia requires the addition of a 03 prefix in front of the area code. This system of differing phone number formats may be acceptable for domestic travel within a user's local area, where only one format of phone number is used consistently. However, differences in phone number formats can make it difficult for a user of a mobile device to dial a phone number when traveling outside of his local area. Additionally, a phone number that a user wishes to dial may be incomplete and may not include all the necessary digits and codes to successfully dial the number from the user's current location.

### BRIEF SUMMARY

According to an implementation of the disclosed subject matter, a method includes receiving a request to dial a phone number to a destination location, wherein the request to dial the phone number is received at a current location. It may be determined that the phone number is formatted to be dialed from a format location. Next, a plurality of candidate phone numbers, may be generated wherein each of the candidate phone numbers is a reformatted version of the phone number based on the destination location, the current location, and the format location. Additionally, a best match candidate phone number may be identified based on a format for dialing the phone number from the current location to the destination location. The best match candidate phone number may be presented along with the plurality of candidate phone numbers. Next, a selection of a candidate phone number may be received.

An implementation of the disclosed subject matter provides a system that includes a processor configured to receive a request to dial a phone number to a destination location, wherein the request to dial the phone number is received at a current location. The system may determine that the phone number is formatted to be dialed from a format location. As a result, the system may generate a plurality of candidate phone numbers, wherein each of the candidate phone numbers is a reformatted version of the phone number based on the destination location, the current location, and the format location. Additionally, a best match candidate phone number may be identified based on a format for dialing the phone number from the current location to the destination location and the best match candidate phone number may be presented along with the plurality of candidate phone numbers. Next, a selection of a candidate phone number may be received.

According to an implementation of the disclosed subject matter, a computer readable medium storing a plurality of instructions that cause a processor to receive a request to dial a phone number to a destination location, wherein the request to dial the phone number is received from a current location. Next, it may be determined that the phone number is formatted to be dialed from a format location. A plurality of candidate phone numbers may be generated, wherein each of the candidate phone numbers is a reformatted version of the phone number based on the destination location, the current location, and the format location. Further, a best match candidate phone number may be identified based on a format for dialing the phone number from the current location to the destination location. The best match candidate phone number may be presented along with the plurality of candidate phone numbers. Next, a selection of a candidate phone number may be received from a user.

Additional features, advantages, and embodiments of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example process according to an implementation of the disclosed subject matter.

FIG. 2 shows an example interface according to an implementation of the disclosed subject matter.

FIG. 3 shows a computer according to an embodiment of the disclosed subject matter.

FIG. 4 shows a network configuration according to an embodiment of the disclosed subject matter.

### DETAILED DESCRIPTION

A mobile phone user usually stores phone numbers in his contact list using the most common format for his country of residence. For example, a resident of the U.S. who remains in the U.S. can format phone numbers according the U.S. format and, similarly, store phonebook numbers according to a format for dialing the phone number from the U.S. However, when the user travels outside the U.S., a problem may arise when trying to dial a phone number stored in a format to be dialed from the U.S. For example, a user may have stored an Indian phone number 011-91-222-222-2222 formatted to be dialed from the U.S. However, if the user travels outside the U.S., for example to Europe, an attempt to dial the Indian number 011-91-222-222-2222 as it is formatted to be dialed from the U.S. may not be successful if an additional and/or other calling code(s), such as an international calling code or international carrier code, are required to complete the call.

Further, phone numbers may come from sources other than a user's phonebook. For example, a user may request to dial a phone number from a website, an email, an advertisement, an application, and the like, and these other sources may provide a phone number in a format unknown to the user and/or in a format that cannot be dialed from the user's device. For example, a user from the U.S. may be traveling in Thailand. He may wish to call a local restaurant he discovered using his favorite city guide application. From within the city guide application, the user may click on the phone number displayed for the local restaurant, thereby requesting to dial the restaurant's phone number. However, the phone number provided by the restaurant may be in a local phone number format for Thailand. Because the user is from the U.S., the local Thailand phone number may require additional numbers, such as an international calling code, a country code, area code, and the like, in order to be dialed from the user's U.S. device.

In addition, there may be instances where the phone number a user wishes to dial is incomplete and requires input from the user to successfully dial the phone number. For example, user who previously lived in Grosse Pointe Woods, Michigan may currently live in Washington, D.C. The user may wish to dial a hair salon that the user knows is located in Grosse Pointe Woods, Mich.; however, the salon's website may display the phone number 889-1111 without an area code. The phone number 889-1111 cannot be dialed from the user's mobile device in Washington, D.C. without an area code. A list of candidate phone numbers may be generated based on the user's current location in Washington, D.C., the destination location of the phone number 889-1111, and the format location of the phone number 889-1111. For example, the system may determine that the phone number 889-1111 exists in multiple area codes, such as the 802 area code, the 226 area code, and the 716 area code. The system may also determine that the Grosse Pointe Woods, Mich. area code 313 has approximately 50,000 phone numbers that have the format 313-88X-XXXX. Accordingly, the list of candidate phone numbers may include 802-889-1111, 226-889-1111, 716-889-1111, and 313-889-1111. Additionally, the candidate phone number 313-889-1111 may be identified, such as by a star or similar identifier, as being the best match candidate phone number. Next, the user may select which candidate phone number to dial from the list. Because the user knows that the hair salon is located in Grosse Pointe Woods, Mich. and the user knows that the 313 area code is for Grosse Pointe Woods, Mich., having previously lived there, the user may select 313-889-1111 to be dialed. In an embodiment, additional information, such as a geographic location associated with an area code, may be presented along with the candidate numbers to assist the user in selecting the correct one. Other examples of additional information can include reverse lookup information, dialing history from the user device or dialing history associated with the user independent of the device on which the numbers are presented and so on.

The present disclosure provides methods and systems for providing a user of a mobile device with a list of candidate phone numbers along with a best candidate phone number, based on a phone number the user has requested to dial. The candidate phone numbers and the best candidate phone number may be based on the destination location of the phone number, the current location in which the call is being placed, and the format location from which the number is formatted to be dialed. Based on this information, multiple candidate phone numbers may be provided when the user initiates dialing a number. The user may then select a candidate phone number from the list to be dialed.

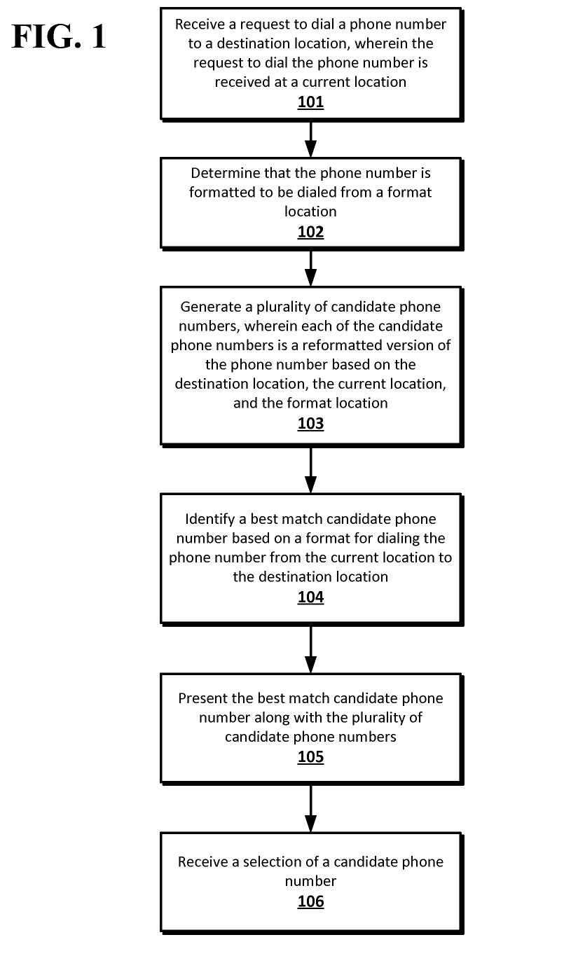

More generally, an implementation of the disclosed subject matter provides a method for providing a list of candidate phone numbers to a user, as shown in FIG. 1. The method may include receiving a request to dial a phone number to a destination location, wherein the request to dial the phone number is received at a current location, at 101. At 102, it may be determined that the phone number is formatted to be dialed from a format location. Next, a plurality of candidate phone numbers may be generated, wherein each of the candidate phone numbers is a reformatted version of the phone number based on the destination location, the current location, and the format location, at 103. A best match candidate phone number may be identified based on a format for dialing the phone number from the current location to the destination location, at 104. The best match candidate phone number may be presented along with the plurality of candidate phone numbers at 105, and a selection of a candidate phone number may be received, at 106. As a result, the selected candidate phone number may be automatically dialed.

An implementation of the disclosed subject matter provides a system that includes a processor configured to receive a request to dial a phone number to a destination location, wherein the request to dial the phone number is received at a current location. The system may determine that the phone number is formatted to be dialed from a format location. As a result, the system may generate a plurality of candidate phone numbers, wherein each of the candidate phone numbers is a reformatted version of the phone number based on the destination location, the current location, and the format location. Additionally, a best match candidate phone number may be identified based on a format for dialing the phone number from the current location to the destination location and the best match candidate phone number may be presented along with the plurality of candidate phone numbers. Next, a selection of a candidate phone number may be received.

According to an implementation of the disclosed subject matter, a computer readable medium storing a plurality of instructions that cause a processor to receive a request to dial a phone number to a destination location, wherein the request to dial the phone number is received from a current location. Next, it may be determined that the phone number is formatted to be dialed from a format location. A plurality of candidate phone numbers may be generated, wherein each of the candidate phone numbers is a reformatted version of the phone number based on the destination location, the current location, and the format location. Further, a best match candidate phone number may be identified based on a format for dialing the phone number from the current location to the destination location. The best match candidate phone number may be presented along with the plurality of candidate phone numbers. Next, a selection of a candidate phone number may be received from a user.

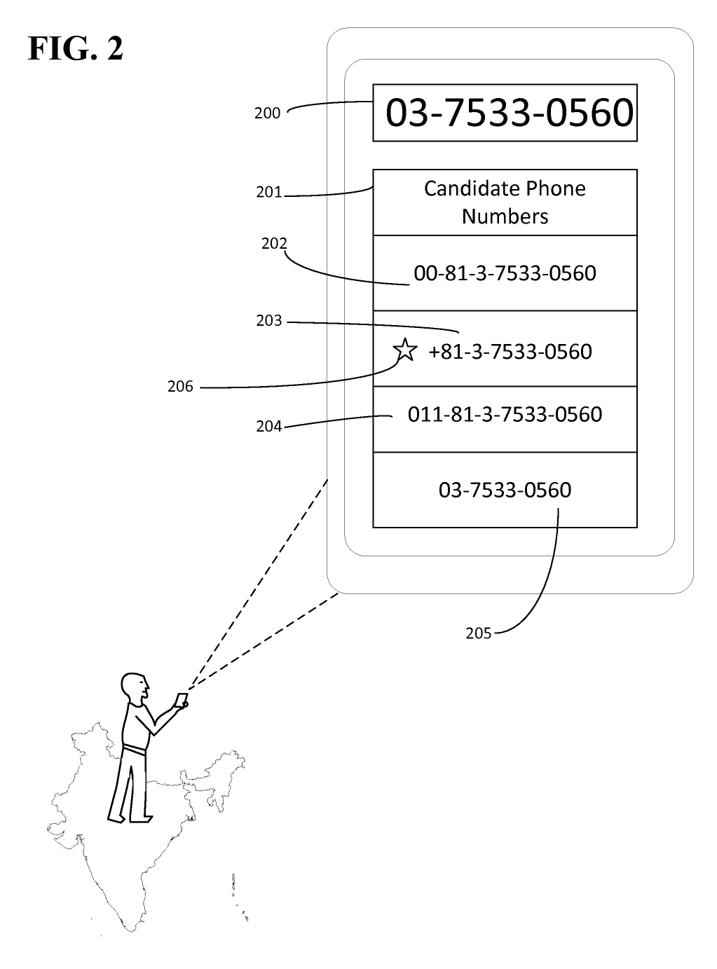

As an example, FIG. 2 shows an interface according to an implementation of the disclosed subject matter. For example, a user who resides in the U.S. may be traveling to India and wish to dial a phone number 200 from a website for a restaurant located in Tokyo. In this case, Tokyo, Japan may be the destination location and India may be the current location. The website for the restaurant may display the Japanese phone number 03-7533-0560 in a format to be dialed from Tokyo, in which case, Tokyo may be the format destination. Additionally, the website may provide written instructions stating “If you are calling from outside of Japan, please dial +81-3-7533-0560.” The user may, for example, select the phone number 03-7533-0560, thereby requesting to dial the phone number 200. As a result, a list of candidate phone numbers 201 may be provided. Each of the candidate phone numbers 202,203,204,205 in the list 201 may be a reformatted version of the phone number 200, such as 00-81-3-7533-0560, +81-3-7533-0560, 011-81-3-7533-0560, and 03-7533-0560. The number +81-3-7533-0560 may be identified as being the best candidate phone number 203, and may be presented to the user as the best candidate phone number by an identifier, for example by being marked with a star 206 or other identifier. Next, the user may have the option to select a candidate phone number 202,203,204,205 from the list of candidate phone numbers 201. Because the user previously read the additional instructions provided on the website, the user may select the candidate phone number +81-3-7533-0560 to be dialed.

As discussed above, the request to dial the phone number may be received on a mobile device. A mobile device may include a smartphone, a tablet, a wearable computer, a phone, a laptop, a wireless device, and any other device capable of receiving a request to dial a phone number. The mobile computing device may have telecommunications access to a phone network. For example, the phone network may include a wired connection, a cell phone network such as a 3G or 4G connection, or cell phone networks such as CDMA or GSM. In an embodiment, the telecommunications access may include Internet technologies, such as VoiP or Wi-Fi, that provide wireless telecommunications access in combination with wireless Internet access.

A phone number and a candidate phone number each may contain a string of Arabic numerals, letters, punctuation marks, characters (such as Chinese characters), pictographs, ideographs, images, etc. The dialed number and the reformatted candidate phone number may each include one or more, without limitation, of a dialing prefix, an international calling code, a country code, a carrier code, an STD code, an area code, a phone number, an exchange code, an extension and any other prefix and/or suffix required to dial the phone number.

Additionally, the source of a phone number to be dialed may be from a user's contact list, a website, an email, an advertisement, an application, and any other similar source from which a user may request to dial a phone number.

In an implementation, reformatting the phone number to generate a plurality of candidate phone numbers can be based on three locations: the destination location, the current location, and the format location. The destination location may be the location of the phone number to be dialed. The current location may be the country in which the user is currently located. The format location may be based on the location from which the phone number is formatted to be dialed. For example, a user currently in Brazil (current location) may wish to dial a Swiss phone number (destination location), and the Swiss phone number may be formatted to be dialed from the U.S. (format location). All three locations may be taken into account to generate a list of candidate phone numbers, each of which is a reformatted version of the original phone number to be dialed. In this particular example, the U.S. format location would indicate that the phone number is in a format that may be successfully dialed if the user were in the U.S. However, because the user is currently in Brazil, the U.S. formatted phone number to Switzerland must be reformatted in order to be dialed successfully while in Brazil. For example, the phone number 011-41-95-238-9381 is a phone number in Switzerland, but is formatted to be dialed from the U.S. In order to be dialed while in Brazil, the phone number may require additional codes and/or digits. For example, in Brazil, the phone number may need to be dialed as 0043-41-95-238-9381 (where 00 is the international call prefix and 43 is a carrier code).

Current location information may be determined based on geolocation, a cell network, SIM card, a network address, a device serial number, a user indication of the current location, a Near Field Communications (NFC) system, a Bluetooth signal and any other location determining technique. Further, destination location and format location may be determined based on various information sources, such as user input, a number format repository, and any other technique for determining the location associated with a phone number and a format of the phone number. A format location may also be determined based on all the above-mentioned signals at a time when a request to dial a phone number is received and/or entered into a device. For example, the inputted phone number may be analyzed by a number reformatting module with the assistance of information from a number format repository. The number format repository may contain several number format templates that correspond with number formats for different countries, regions, cities, states, network zones and the like. For example, templates for India would be programmed to recognize phone numbers with 2-4 digit subscriber trunk dialing (STD) codes as well as 6-8 digit landline numbers. It is to be noted that different types of templates might apply for different types of numbers, for example cell numbers, landline numbers, or emergency numbers. An inputted number may be compared to the known number format templates, and the destination location and format location may be determined based on a match between the phone number format and a number format template. For example, the phone number 650-012-3456 may be compared with the number format templates and it may be determined that the phone number matches the number format template for Mountain View, Calif., and the number matches the format template for dialing from anywhere within the U.S. Accordingly, the destination location may be Mountain View, Calif. and the format location may be the U.S.

In an implementation, the destination location and the format location may be the same, the current location and the destination location may be the same, and the current location and the format location may be the same.

Additional information may be taken into account when generating a candidate phone number, including a user's contact list, address book, phone number databases, websites, applications, and any other source of information that may help with identifying missing data needed for dialing a phone number. Further, the user's own phone number may be taken into account when generating a candidate phone number. For example, if a user's mobile phone number is +1 650 012 3456, and the user has requested to dial a US phone number that is missing an area code, there may be a chance that the area code is the same as the user's area code (650). As another example, a user, living in Arlington, Va., may have stored in his contact list, a contact entry for a friend, including a phone number and address. The friend's phone number may be a local Arlington number, 012-3456. The user may also have stored address information for his friend. This address information may include the friend's city, state, and zip code, for example, Arlington, Va. 20002. When the user dials the friend's phone number while in the local Arlington area, an area code may not be required to dial the phone number 012-3456. However, if the user travels outside the local Arlington area, an attempt to dial the phone number 012-3456 may not be successful since an area code may be required to complete the call. When a request to dial the friend's phone number 012-3456 is made outside of the local Arlington area, the friend's address information may be used to generate a candidate phone number. As such, based on the friend's address information Arlington, Va. 20002, it may be determined that 703 is a common area code for the Arlington area. Accordingly, a candidate phone number 703-012-3456 may be generated.

Additional information may be extracted from the user's contact list and used to generate a candidate phone number, such as a statistical analysis of a user's contact list which may provide information for generating a candidate phone number. For example, if 90% of the phone numbers in a user's contact list are U.S. phone numbers, and the user has requested to dial a phone number for which the format location is unknown, there may be a high likelihood that the format location is the U.S. A similar statistical analysis may help to determine a missing area code for a phone number the user wishes to dial.

As another example, a user in India may wish to dial the phone number to a restaurant, Mr. Chow in Miami, Fla. The phone number 012-3456 may be displayed on the restaurant website and the user may click on the phone number to request to dial the phone number. However, the phone number 012-3456 may require additional digits in order to be dialed from India. Based on additional information on the restaurant website, such as the restaurant address 2201 Collins Avenue Miami Beach, Fla. 33139, the area code 305 for the destination location Miami Beach area may be determined. Further, the number 305-012-3456 may be compared with known phone number formats for dialing a U.S. phone number from India. Accordingly, a list of candidate phone numbers may be generated including, for example, 305-012-3456, 001-305-012-3456, and +1-305-012-3456.

In an implementation, the list of candidate phone numbers may be prioritized from best candidate to worst. For example, the best match candidate phone number may be presented first in the list followed by other candidate phone numbers in order of most likely to be successfully dialed to the least. Further, a best match candidate phone number may be distinguished from other candidate phone numbers by an identifier, such as a star, graphic, color coding, and any other similar identifier.

In an implementation, the communication between a device and a candidate phone number list provider may be across one or more bridges between the interfaces. For example, the communications between the device and the candidate phone number list provider may be managed or assisted by a third device, such as, a coordinating device, a local coordinator, a remote server, etc. In such cases, the third device may, for example, determine that the phone number is formatted to be dialed from a format location. The third device may then provide the phone number to the candidate phone number list provider, in which case, the candidate phone number list provider may provide a list of candidate phone numbers to the device. Alternatively, the third device may receive an indication from the device that the phone number is formatted to be dialed from a format location and provide the phone number to the candidate phone number list provider. The candidate phone number list provider may generate a plurality of candidate phone numbers. Accordingly, the candidate phone number list provider may a list of candidate phone numbers to the device. In an embodiment, the third device may also act as a bridge between the candidate phone number list provider and the device when generating a list of candidate phone numbers, identifying a best match candidate phone number, and providing the list of candidate phone numbers to the device. Furthermore, more than one intermediate device may be implemented to facilitate communication between devices and an application provider.

In situations in which the implementations of the disclosed subject matter collect personal information about users, or may make use of personal information, the users may be provided with an opportunity to control whether programs or features collect user information (e.g., user's geographic location, user's contact list, user call history, user location history, and other user information upon which candidate phone numbers may be based), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

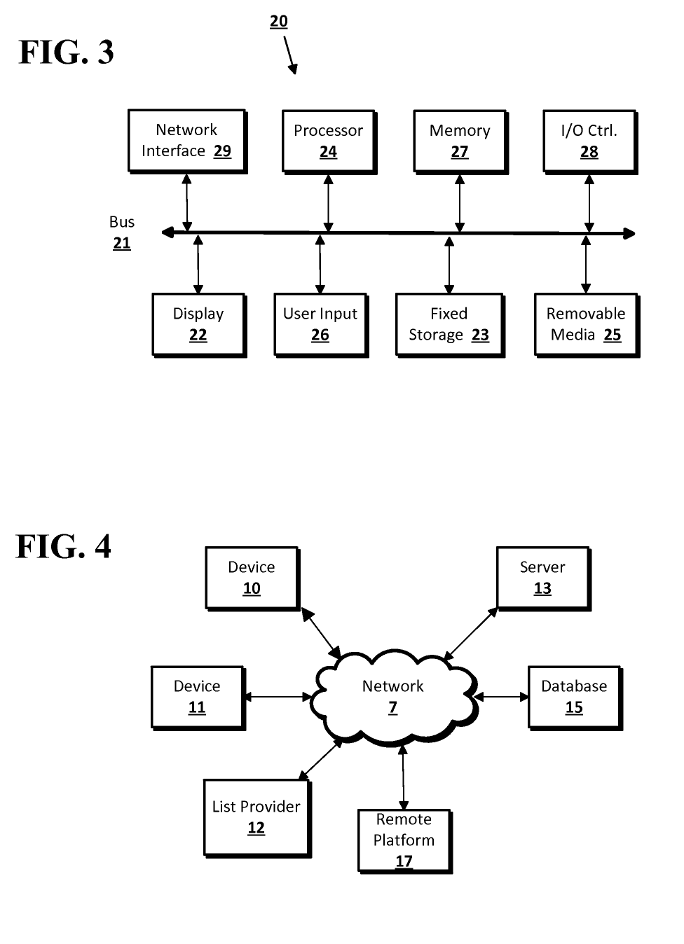

Embodiments of the presently disclosed subject matter may be implemented in and used with a variety of component and network architectures. FIG. 3 is an example computer 20 suitable for implementing embodiments of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 4.

Many other devices or components (not shown) may be connected in a similar manner (e.g., document scanners, digital cameras and so on). Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, removable media 25, or on a remote storage location.

FIG. 4 shows an example network arrangement according to an embodiment of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
receiving a request to dial a phone number to a destination location, wherein the request to dial the phone number is received at a current location,
determining that the phone number is formatted to be dialed from a format location,
generating a plurality of candidate phone numbers, wherein each of the candidate phone numbers is a reformatted version of the phone number based on the destination location, the current location, and the format location,
identifying a best match candidate phone number based on a format for dialing the phone number from the current location to the destination location,
presenting the best match candidate phone number along with the plurality of candidate phone numbers, and
receiving a selection of a candidate phone number.

2. The method of claim 1, further comprising automatically dialing the selected candidate phone number.

3. The method of claim 1, wherein the request to dial the phone number is received on a mobile device.

4. The method of claim 3, wherein the mobile device is selected from the group consisting of: a smartphone, a tablet, a wearable computer, a phone, a laptop, a wireless device, and any other device capable of receiving a request to dial a phone number.

5. The method of claim 1, wherein the current location is a location which is determined based on at least one selected from the group consisting of: a geolocation, a network address, a device serial number, and a user indication of the current location.

6. The method of claim 1, wherein the destination location and the format location are the same.

7. The method of claim 1, wherein the current location and the destination location are the same.

8. The method of claim 1, wherein the current location and the format location are the same.

9. The method of claim 1, wherein the reformatted version of the phone number includes at least one selected from the group consisting of: the phone number, an international calling code, a country code, an area code, a carrier code, a subscriber trunk dialing code, an exchange code, and any other prefix and/or suffix required to dial the phone number.

10. A system comprising:
a processor configured to:
receive a request to dial a phone number to a destination location, wherein the request to dial the phone number is received at a current location,
determine that the phone number is formatted to be dialed from a format location,
generate a plurality of candidate phone numbers, wherein each of the candidate phone numbers is a reformatted version of the phone number based on the destination location, the current location, and the format location,
identify a best match candidate phone number based on a format for dialing the phone number from the current location to the destination location,
present the best match candidate phone number along with the plurality of candidate phone numbers, and
receive a selection of a candidate phone number.

11. The system of claim 10, further comprising automatically dialing the selected candidate phone number.

12. The system of claim 10, wherein the request to dial the phone number is received on a mobile device.

13. The system of claim 12, wherein the mobile device is selected from the group consisting of: a smartphone, a tablet, a wearable computer, a phone, a laptop, a wireless device, and any other device capable of receiving a request to dial a phone number.

14. The system of claim 10, wherein the current location is a location which is determined based on at least one selected from the group consisting of: geolocation, a network address, n device serial number, and a user indication of the current location.

15. The system of claim 10, wherein the destination location and the format location are the same.

16. The system of claim 10, wherein the current location and the destination location are the same.

17. The system of claim 10, wherein the current location and the format location are the same.

18. The system of claim 10, wherein the reformatted version of the phone number includes at least one selected from the group consisting of: the phone number, an international calling code, a country code, an area code, a carrier code, an code, an exchange code, and any other prefix and/or suffix required to dial the phone number.

19. A computer readable medium storing a plurality of instructions that cause a processor to:
receive a request to dial a phone number to a destination location, wherein the request to dial the phone number is received from a current location,
determine that the phone number is formatted to be dialed from a format location,
generate a plurality of candidate phone numbers, wherein each of the candidate phone numbers is a reformatted version of the phone number based on the destination location, the current location, and the format location,
identify a best match candidate phone number based on a format for dialing the phone number from the current location to the destination location,
present the best match candidate phone number along with the plurality of candidate phone numbers, and
receive a selection of a candidate phone number.

20. The computer readable medium of claim 19, further comprising automatically dialing the selected candidate phone number.

21. The computer readable medium of claim 19, wherein the request to dial the phone number is received on a mobile device.

22. The computer readable medium of claim 21, wherein the mobile device is selected from the group consisting of: a smartphone, a tablet, a wearable computer, a phone, a laptop, a wireless device, and any other device capable of receiving a request to dial a phone number.

23. The computer readable medium of claim 19, wherein the current location is a location which is determined based on at least one selected from the group consisting of: geolocation, a network address, a device serial number, and a user indication of the current location.

24. The computer readable medium of claim 19, wherein the destination location and the format location are the same.

25. The computer readable medium of claim 19, wherein the current location and the destination location are the same.

26. The computer readable medium of claim 19, wherein the current location and the format location are the same.

27. The computer readable medium of claim 19, wherein the reformatted version of the phone number includes at least one selected from the group consisting of: the phone number, an international calling code, a country code, an area code, a carrier code, a subscriber trunk dialing code, an exchange code, and any other prefix and/or suffix required to dial the phone number.
